(19) United States
(12) Patent Application Publication
(10) Pub. No.: US 2016/0026993 A1
(43) Pub. Date: Jan. 28, 2016

(54) ELECTRONIC APPARATUS AND PAYMENT METHOD THEREOF

(71) Applicant: Samsung Electronics Co., Ltd., Suwon-si (KR)

(72) Inventor: Moon Seok KANG, Suwon-si (KR)

(21) Appl. No.: 14/807,045

(22) Filed: Jul. 23, 2015

(30) Foreign Application Priority Data
Jul. 24, 2014 (KR) 10-2014-0094175

(51) Int. Cl. G06Q 20/32; H04L 12/703; H04W 40/02

(52) U.S. Cl. CPC G06Q 20/3227; G06Q 20/327; H04W 40/02; H04L 45/28

(57) ABSTRACT

An electronic device is provided. The electronic device includes a communication module including a routing table for storing routing paths for short-range wireless communication payment, wherein the communication module is configured to route an application identifier (AID) selection signal to an secure element (SE) according to the routing paths stored in the routing table when the AID selection signal is received from a payment reader, a memory configured to store an AID list including a routing path of a short-range wireless communication payment application installed in the electronic device, and a control module configured to search the AID corresponding to the AID selection signal from the AID list if a routing path corresponding to the AID selection signal does not exist in the routing table or a response of the SE to the routing indicates failure, and to control to store a routing path of an AID corresponding to a routing path selection signal in the routing table if the routing path corresponding to the routing path selection signal exists in the AID list.

### CROSS-REFERENCE TO RELATED APPLICATION(S)

This application claims the benefit under 35 U.S.C. §119(a) of a Korean patent application filed on Jul. 24, 2014 in the Korean Intellectual Property Office and assigned Serial Number 10-2014-0094175, the entire disclosure of which is hereby incorporated by reference.

### TECHNICAL FIELD

The present disclosure relates to an electronic device and a payment method therefor.

### BACKGROUND

Various types of electronic products have been developed with the development of electronic technology. Recently, mobile electronic devices such as smartphones, tablet personal computers (PCs), and the like are widely used. Such mobile electronic devices are multifunctional as to provide various functions, for example, shooting a picture, music playback, video playback, an electronic mail service, a social networking service (SNS), and the like.

Furthermore, a technology for providing a payment service using a short-range communication technology such as bluetooth (BT), near field communication (NFC), or the like has been developed. Such a technology for providing a payment service through a mobile electronic device may enable integration of a payment means such as a credit card or the like and a device.

A mobile electronic device may include at least one secure element (SE) for storing various information used for payment so that a user may use a payment service through the mobile electronic device. The SE may include information on at least one payment application, and each payment application may include at least one application identifier (AID). A wireless communication module in the mobile electronic device may include a routing table for storing at least one piece of routing information among an AID of a payment application, a protocol, and a technology.

If a user of an electronic device taps an electronic device on a payment reader, the electronic device may perform payment by processing information received from the payment reader according to the routing information stored in the routing table of the wireless communication module. However, since the routing table is limited in capacity, the routing table is unable to store all pieces of routing information. If routing information required for payment is not stored in the routing table or erroneous routing formation is stored therein, the payment cannot be performed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device capable of performing routing using a routing table that is limited in capacity, and a payment method therefor.

Another aspect of the present disclosure is to provide an electronic device for enabling a user to perform payment normally without being aware of payment failure that occurs due to a limitation in capacity of a routing table, and a payment method therefor.

In accordance with an aspect of the present disclosure, an electronic device is provided. The electronic device includes a communication module including a routing table for storing routing paths for short-range wireless communication payment, wherein the communication module is configured to route an application identifier (AID) selection signal to a secure element (SE) according to the routing paths stored in the routing table when the AID selection signal is received from a payment reader, a memory configured to store an AID list including a routing path of a short-range wireless communication payment application installed in the electronic device, and a control module configured to search an AID corresponding to the AID selection signal from the AID list if a routing path corresponding to the AID selection signal does not exist in the routing table or a response of the SE to the routing indicates failure, and to control to store a routing path of an AID corresponding to a routing path selection signal in the routing table if the routing path corresponding to the routing path selection signal exists in the AID list.

In accordance with another aspect of the present disclosure, a payment method for an electronic device is provided. The electronic device includes receiving an AID selection signal from a payment reader, routing the AID selection signal to an SE according to a routing table in which routing paths for short-range wireless communication payment are stored, searching an AID list including a routing path of a short-range wireless communication payment application installed in the electronic device for an AID corresponding to the AID selection signal if a routing path corresponding to the AID selection signal does not exist in the routing table or a response of the SE to the routing indicates failure, and storing the routing path corresponding to the AID selection signal in the routing table if the AID corresponding to the AID selection signal exists in the AID list.

In accordance with another aspect of the present disclosure, a non-transitory computer-readable recording medium records a program for carrying out a method is provided. The method includes receiving an AID selection signal from a payment reader, routing the AID selection signal to an SE according to a routing table in which routing paths for short-range wireless communication payment are stored, searching an AID list including a routing path of a short-range wireless communication payment application installed in the electronic device for an AID corresponding to the AID selection signal if a routing path corresponding to the AID selection signal does not exist in the routing table or a response of the SE to the routing indicates failure, and storing the routing path corresponding to the AID selection signal in the routing table if the AID corresponding to the AID selection signal exists in the AID list.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure.

FIG. 2 is a diagram illustrating a user interface (UI) for application identifier (AID) selection according to an embodiment of the present disclosure.

FIG. 3 is a diagram illustrating a UI for providing a guide for tapping an electronic device according to an embodiment of the present disclosure.

FIG. 4 is a block diagram illustrating an electronic device according to various embodiments of the present disclosure.

FIG. 5 is a flowchart illustrating a payment method for an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include,” “comprise,” “including,” or “comprising” used herein indicates disclosed functions, operations, or existence of elements but does not exclude other functions, operations or elements. It should be further understood that the term “include”, “including”, “comprise”, “comprising”, “have”, or “having” used herein specifies the presence of stated features, numbers, operations, elements, components, or combinations thereof but does not preclude the presence or addition of one or more other features, numbers, operations, elements, components, or combinations thereof.

The meaning of the term “or” or “at least one of A and/or B” used herein includes any and all combinations of words listed together with the term. For example, the wording “A or B” or “at least one of A and/or B” may indicate A, B, or both A and B.

The terms such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, a first user device and a second user device indicate different user devices. For example, without departing the scope of the present disclosure, a first element may be named as a second element, and similarly, a second element may be named as a first element.

It will be understood that when an element is referred to as being “connected” or “coupled” to another element, it can be directly connected or coupled to the other element or intervening elements may be present. In contrast, when an element is referred to as being “directly connected” or “directly coupled” to another element, it should be understood that there are no intervening elements.

The terminology used herein is not for delimiting the present disclosure but for describing specific various embodiments of the present disclosure. The terms of a singular form may include plural forms unless otherwise specified.

The terms used herein, including technical or scientific terms, have the same meanings as understood by those skilled in the art unless otherwise defined herein. The commonly used terms such as those defined in a dictionary should be interpreted in the same context as in the related art and should not be interpreted in an idealized or overly formal detect unless otherwise defined explicitly.

Electronic devices according to various embodiments of the present disclosure may have a payment function. For example, the electronic devices may include at least one of smartphones, tablet personal computers (PCs), mobile phones, video telephones, electronic book readers, desktop PCs, laptop PCs, netbook computers, personal digital assistants (PDAs), portable multimedia players (PMPs), motion picture experts group (MPEG-1 or MPEG-2) audio layer 3 (MP3) players, mobile medical devices, cameras, or wearable devices (e.g., head-mounted-devices (HMDs) such as electronic glasses, electronic apparels, electronic bracelets, electronic necklaces, electronic appcessories, electronic tattoos, or smart watches).

According to various embodiments of the present disclosure, the electronic devices may be smart home appliances having a payment function. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, or electronic picture frames.

According to various embodiments of the present disclosure, the electronic devices may include at least one of medical devices (e.g., a magnetic resonance angiography (MRA), a magnetic resonance imaging (MRI), a computed tomography (CT), scanners, ultrasonic devices, or the like), navigation devices, global positioning system (GPS) receivers, event data recorders (EDRs), flight data recorders (FDRs), vehicle infotainment devices, electronic equipment for ships (e.g., navigation systems and gyrocompasses), avionics, security devices, head units for vehicles, industrial or home robots, automatic teller's machines (ATMs), or points of sales (POSs).

According to various embodiments of the present disclosure, the electronic devices may include at least one of parts of furniture or buildings/structures, electronic boards, electronic signature receiving devices, projectors, or measuring instruments (e.g., water meters, electricity meters, gas meters, or wave meters) having a payment function. The electronic devices according to various embodiments of the present disclosure may be one or more combinations of the above-mentioned devices. Furthermore, the electronic devices according to various embodiments of the present disclosure may be flexible devices. It would be obvious to those skilled in the art that the electronic devices according to various embodiments of the present disclosure are not limited to the above-mentioned devices.

Hereinafter, electronic devices according to various embodiments of the present disclosure will be described with reference to the accompanying drawings. The term “user” used herein may refer to a person who uses an electronic device or may refer to a device (e.g., an artificial electronic device) that uses an electronic device.

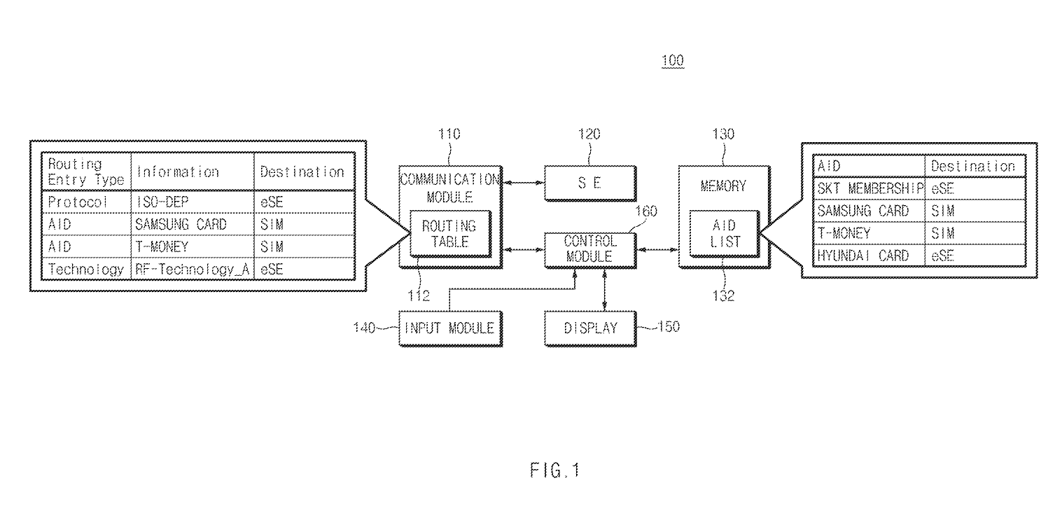

FIG. 1 is a block diagram illustrating a configuration of an electronic device according to an embodiment of the present disclosure.

Referring to FIG. 1, an electronic device 100 may include a communication module 110, a secure element (SE) 120, a memory 130, an input module 140, a display 150, and a control module 160.

The communication module 110 may communicate with a payment reader (not shown). According to an embodiment of the present disclosure, the communication module 110 may be connected to the payment reader through a wireless network. For example, the communication module 110 may be connected to the payment reader using a short-range wireless communication technology such as near field communication (NFC).

According to an embodiment of the present disclosure, the communication module 110 may include a routing table 112. According to an embodiment of the present disclosure, the routing table 112 may store a routing path for a payment service. For example, the routing table 112 may store an application identifier (AID) routing path (or a storage location), a protocol routing path, or a technology routing path of a payment application.

If the electronic device 100 is tapped on the payment reader, the communication module 110 may receive payment request information including an AID selection signal from the payment reader. The AID selection signal may include information on a specific AID with which payment is to be performed. Upon receiving the AID selection signal from the payment reader, the communication module 110 may route the AID selection signal to the SE 120 according to the routing path stored in the routing table 112. For example, the communication module 110 may perform AID-based routing, protocol-based routing, or technology-based routing. For example, in the case where the routing path of a Samsung card AID is set to be a universal subscriber identity module (USIM) in the routing table 112, the Samsung card AID selection signal received from the payment reader may be routed to the USIM. For another example, in the case where the routing path of a protocol A is set to be an embedded secure element (eSE) in the routing table 112, all signals of the protocol A may be routed to the eSE.

According to an embodiment of the present disclosure, the communication module 110 may perform routing in an order of AID-based routing, protocol-based routing, and technology-based routing. For example, if the electronic device 100 is tapped on the payment reader, the communication module 110 may attempt to perform the AID-based routing first, and then may attempt to perform the protocol-based routing if there is no AID routing path corresponding to the AID selection signal in the routing table 112. Then, if there is no protocol routing path in the routing table 112, the communication module 110 may attempt to perform the technology-based routing.

According to an embodiment of the present disclosure, if there is no routing path corresponding to the AID selection signal in the routing table 112, the communication module 110 may transmit routing failure information to the control module 160.

According to an embodiment of the present disclosure, upon receiving the AID selection signal from the payment reader, the communication module 110 may transmit the received AID selection signal to the control module 160.

According to an embodiment of the present disclosure, upon receiving the AID selection signal, the communication module 110 may route the AID selection signal to the specific SE 120 according to the routing path information stored in the routing table 112, and may transfer a result of a response from the SE 120 to the control module 160. According to an embodiment of the present disclosure, based on the AID and the SE response received from the communication module 110, the control module 160 may determine whether to update the routing table stored in the communication module 110.

According to an embodiment of the present disclosure, the communication module 110 may be implemented with one chip (e.g., an NFC chip). According to an embodiment of the present disclosure, the communication module 110 may be removable from the electronic device 100.

The SE 120 may store various personal information required for payment, such as card information, electronic money information, or the like. For example, the SE 120 may be implemented with a SIM, a universal SIM (USIM), an eSE, a universal IC card (UICC), or the like. According to an embodiment of the present disclosure, a part or the entirety of the memory 130 may be operated as an SE. According to an embodiment of the present disclosure, the electronic device 100 may include at least one (e.g., two or more) SE.

According to an embodiment of the present disclosure, upon receiving the AID selection signal routed from the communication module 110, the communication module 110 may transmit, to the communication module 110, a response to the routing of the AID selection signal. For example, upon receiving the AID selection signal, the SE 120 may determine whether payment information (or an application) corresponding to the AID selection signal exists. For example, upon receiving the Samsung card AID selection signal from the communication module 110, the SE 120 may determine whether Samsung card payment information (or a Samsung card application) exists. If the Samsung card payment information exists, the SE 120 may notify the communication module 110 of AID selection success, but, if the Samsung card payment information does not exist, the SE 120 may notify the communication module 110 of AID selection failure.

The memory 130 may store an AID list 132 of a payment application installed in the electronic device 100. According to an embodiment of the present disclosure, the AID list 132 may include information on a routing path of the payment application (or AID) installed in the electronic device 100. For example, the AID list 132 may include information on what payment application is included for each SE120 of the electronic device 100 or what AID is included for each application.

The input module 140 may receive a user input. According to an embodiment of the present disclosure, if there exists a plurality of AIDs corresponding to the AID selection signal in the AID list 132, the input module 140 may receive the user input for selecting one of the plurality of AIDs.

According to an embodiment of the present disclosure, the input module 140 may be implemented with at least one of a touch screen or a touch pad operated by a touch input from a user, a keypad or a keyboard having various function keys, numeric keys, special keys, and character keys, a motion recognition sensor for recognizing a motion of the user, and a voice recognition sensor for recognizing a voice of the user.

If there exists the plurality of AIDs corresponding to the AID selection signal in the AID list 132, the display 150 may display a user interface (UI) for receiving the user input for selecting one of the plurality of AIDs (or payment applications) corresponding to the AID selection signal.

According to an embodiment of the present disclosure, if a routing path corresponding to the AID selection signal is stored in the routing table, the display 150 may display a UI for providing a guide for tapping the electronic device 100 to the payment reader.

The control module 160 may control overall operation of the electronic device 100. According to an embodiment of the present disclosure, the control module 160 may control each of the communication module 110, the SE 120, the memory 130, the input module 140, and the display 150 so that payment is performed through the electronic device according to various embodiments of the present disclosure.

According to an embodiment of the present disclosure, the control module 160 may receive the AID selection signal from the communication module 110.

According to an embodiment of the present disclosure, the control module 160 may receive, from the communication module 110, a result of a response of the SE 120 to the AID selection signal. According to an embodiment of the present disclosure, if the response of the SE 120 to the AID selection signal indicates unavailability of payment, the control module 160 may search the AID list 132 stored in the memory 130 for an AID corresponding to the AID selection signal.

According to another embodiment of the present disclosure, if the control module 160 receives routing failure information from the communication module 110 since a routing path corresponding to the AID selection signal does not exist in the routing table 112 (e.g., if there exists no AID routing path, protocol routing path, or technology routing path corresponding to the AID selection signal), the control module 160 may search the AID list 132 stored in the memory 130 for an AID corresponding to the AID selection signal.

According to an embodiment of the present disclosure, if there exists an AID corresponding to the AID selection signal in the AID list 132, the control module 160 may store (or update) a routing path corresponding to the AID selection signal in the routing table 112. For example, in the case of adopting the AID-based routing, if payment information corresponding to the AID selection signal is stored in an eSE, an AID routing path corresponding to the AID selection signal may be set to be the eSE. For another example, in the case of adopting the protocol-based routing, if payment information corresponding to the AID selection signal is stored in a USIM, a protocol routing path corresponding to the AID selection signal may be set to be the USIM. Accordingly, if there is no routing path corresponding to the AID selection signal in the routing table 112 or an erroneous routing path is stored therein, the control module 160 may update the routing table 112 with a correct routing path so that payment is performed.

According to an embodiment of the present disclosure, if there exists an AID corresponding to the AID selection signal in the AID list 132, the control module 160 may determine whether a routing path of the AID corresponding to the AID selection signal and searched from the AID list 132 is identical to a previous routing path (or a routing path stored in the routing table 112). If the routing path of the AID corresponding to the AID selection signal and searched from the AID list 132 is different from the previous routing path, the control module 160 may update the routing table 112.

According to an embodiment of the present disclosure, the control module 160 may store, in the routing table 112, routing paths of all AIDs related to a payment application including an AID corresponding to the AID selection signal. For example, if the AID corresponding to the AID selection signal is the Samsung card AID, and a Samsung card payment application includes the Samsung card AID, a CJ membership AID, and a T-money AID, the control module 160 may store, in the routing table 112, routing paths of the Samsung card AID, the CJ membership AID, and the T-money AID.

According to an embodiment of the present disclosure, if there exists a plurality of AIDs (or a plurality of payment applications) corresponding to the AID selection signal in the AID list 132, the control module 160 may select one of the plurality of AIDs to store a routing path. For example, the control module 160 may store, in the routing table 112, a routing path (e.g., an AID routing path, a protocol routing path, or a technology routing path) of an AID selected by the user from among the plurality of AIDs. According to an embodiment of the present disclosure, the display 150 may provide a UI for receiving a user input for selecting one of the plurality of AIDs. For another example, the control module 160 may store a routing path of one of the plurality of AIDs in the routing table 112 according to a specified priority order. For example, the control module 160 may store a routing path of a frequently used AID (or payment application) in the routing table 112.

According to an embodiment of the present disclosure, if a space for storing an AID corresponding to the AID selection signal (or all AIDs related to a payment application including the AID corresponding to the AID selection signal) is insufficient, the control module 160 may delete at least a portion of the routing paths stored in the routing table 112. For example, the control module 160 may delete at least a portion of the routing paths stored in the routing table 112 in an ascending order of frequency of use. For another example, the control module 160 may delete at least a portion of the routing paths stored in the routing table 112 in an order of storage time (i.e., in a first-in first-out manner).

If a routing path corresponding to the AID selection signal received from the payment reader is stored in the routing table 112 to thereby update the routing table 112, the communication module 110 may perform routing according to the updated routing table 112 so that payment is performed. For example, if the routing table 112 is updated, the communication module 110 may automatically perform routing according to an updated routing path. Accordingly, even if payment fails due to a limitation in capacity of the routing table, the electronic device may perform payment without allowing the user to be aware of the payment failure. For another example, if the electronic device is tapped on the payment reader again after the routing table 112 is updated, the communication module 110 may perform routing according to an updated routing path. Accordingly, even if payment fails due to a limitation in capacity of the routing table, the user may perform payment with ease through a UI provided by the electronic device, without manually updating the routing table.

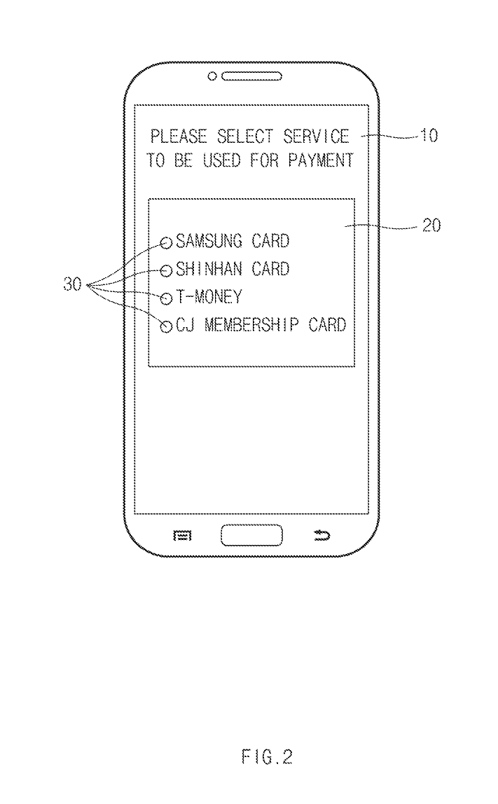

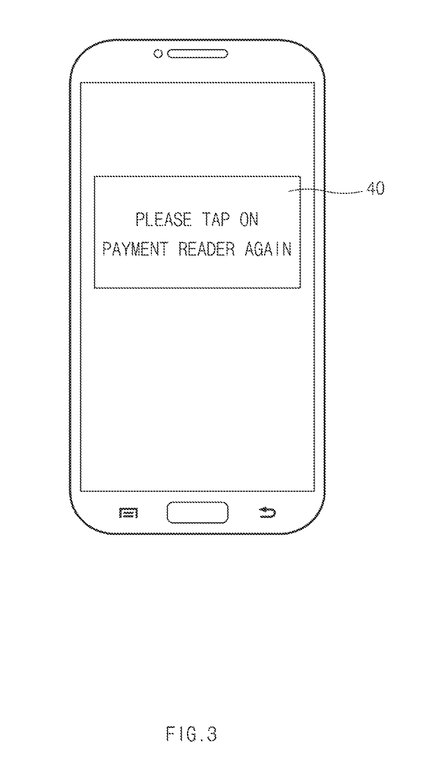

A UI displayed on the display 150 will be described with reference to FIGS. 2 and 3.

FIG. 2 is a diagram illustrating a UI for AID selection according to an embodiment of the present disclosure.

According to an embodiment of the present disclosure, if there exists a plurality of AIDs corresponding to the AID selection signal in the AID list 132, the display 150 may display a UI for receiving a user input for selecting one of the plurality of AIDs (or payment applications) corresponding to the AID selection signal. Referring to FIG. 2, the display 150 may display an object 10 for providing a guide to selecting one of the plurality of AIDs (or payment applications) and a selection window 20 for selecting one of the plurality of AIDs. Selection buttons 30 for respectively selecting the plurality of AIDs may be displayed on the selection window 20. The user may input a user input (e.g., a touch input) through one of the selection buttons 30 so as to select one of the plurality of AIDs.

FIG. 3 is a diagram illustrating a UI for providing a guide for tapping an electronic device according to an embodiment of the present disclosure.

According to an embodiment of the present disclosure, if a routing path corresponding to the AID selection signal is stored in the routing table, the display 150 may display a UI for providing a guide for tapping the electronic device 100 to the payment reader.

For example, as illustrated in FIG. 3, the display 150 may display a UI for showing a message 40 of “Please tap on the payment reader again”.

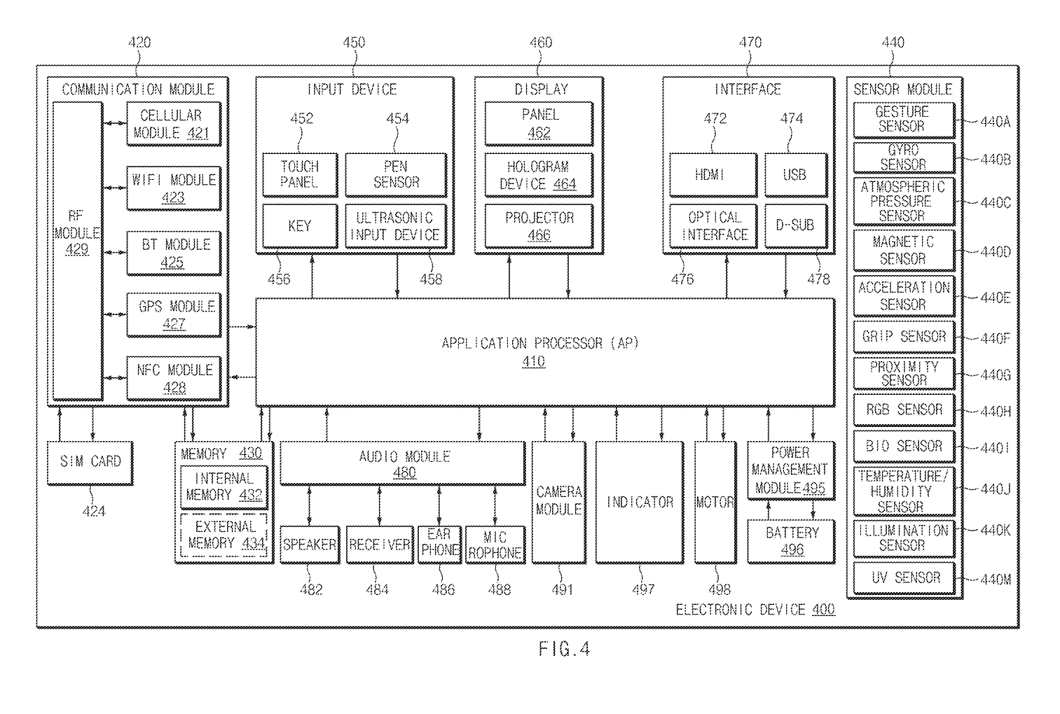

FIG. 4 is a block diagram illustrating an electronic device 400 according to various embodiments of the present disclosure. The electronic device 400 may constitute, for example, a part or the entirety of the electronic device 100 illustrated in FIG. 1.

Referring to FIG. 4, the electronic device 400 may include at least one application processor (AP) 410, a communication module 420, a subscriber identification module (SIM) card 424, a memory 430, a sensor module 440, an input device 450, a display 460, an interface 470, an audio module 480, a camera module 491, a power management module 495, a battery 496, an indicator 497, and a motor 498.

The AP 410 (e.g., the control module 160) may control a plurality of hardware or software elements connected to the AP 410 by running an operating system or an application program, and may process various data including multimedia data and may perform an operation thereon. The AP 410 may be implemented with, for example, a system on chip (SoC). According to an embodiment of the present disclosure, the AP 410 may further include a graphic processing unit (GPU) (not shown).

The communication module 420 may perform data transmission/reception for communication between the electronic device 400 (e.g., the electronic device 100) and other electronic devices connected thereto through a network. According to an embodiment of the present disclosure, the communication module 420 may include a cellular module 421, a Wi-Fi module 423, a BT module 425, a GPS module 427, an NFC module 428, and a radio frequency (RF) module 429.

The cellular module 421 may provide a voice call service, a video call service, a text message service, or an Internet service through a telecommunications network (e.g., a long term evolution (LTE), LTE-advanced (LTE-A), code division multiple access (CDMA), wireless CDMA (WCDMA), universal mobile telecommunications system (UMTS), wireless broadband (WiBro) or global system for mobile (GSM) network). Furthermore, the cellular module 421 may identify and authenticate electronic devices in the telecommunications network using, for example, a (e.g., the SIM card 424). According to an embodiment of the present disclosure, the cellular module 421 may perform at least a part of functions provided by the AP 410. For example, the cellular module 421 may perform at least a part of a multimedia control function.

According to an embodiment of the present disclosure, the cellular module 421 may include a communication processor (CP). The cellular module 421 may be implemented with, for example, an SoC. Although FIG. 4 illustrates that the cellular module 421 (e.g., a communication processor), the memory 430, and the power management module 495 are separate from the AP 410, the AP 410 may include at least a part of the foregoing elements (e.g., the cellular module 421), according to an embodiment of the present disclosure.

According to an embodiment of the present disclosure, the AP 410 or the cellular module 421 (e.g., a communication processor) may load, on a volatile memory, a command or data received from nonvolatile memories connected to the AP 410 and the cellular module 421 respectively or at least one of other elements, so as to process the command or data. Furthermore, the AP 410 or the cellular module 421 may store, in the nonvolatile memory, data received from or generated by at least one of the other elements. Each of the Wi-Fi module 423, the BT module 425, the GPS module 427, and the NFC module 428 may include, for example, a processor for processing data transmitted/received through the modules. FIG. 4 illustrates that the cellular module 421, the Wi-Fi module 423, the BT module 425, the GPS module 427, and the NFC module 428 are separate blocks. However, according to an embodiment of the present disclosure, at least a part (e.g., two or more) of the cellular module 421, the Wi-Fi module 423, the BT module 425, the GPS module 427, and the NFC module 428 may be included in a single integrated chip (IC) or IC package. For example, at least a part (e.g., a communication processor corresponding to the cellular module 421 and a Wi-Fi processor corresponding to the Wi-Fi module 423) of the cellular module 421, the Wi-Fi module 423, the BT module 425, the GPS module 427, and the NFC module 428 may be implemented with a single SoC.

The RF module 429 may transmit/receive data, for example, may transmit/receive RF signals. Although not illustrated, for example, a transceiver, a power amp module (PAM), a frequency filter or a low noise amplifier (LNA) may be included in the RF module 429. Furthermore, the RF module 429 may further include a component such as a conductor or a wire for transmitting/receiving free-space electromagnetic waves in a wireless communication system. FIG. 4 illustrates that the cellular module 421, the Wi-Fi module 423, the BT module 425, the GPS module 427, and the NFC module 428 share the single RF module 429. However, according to an embodiment of the present disclosure, at least one of the cellular module 421, the Wi-Fi module 423, the BT module 425, the GPS module 427, or the NFC module 428 may transmit/receive RF signals through an additional RF module.

The SIM card 424 may include a SIM, and may be inserted into a slot formed at a specific portion of the electronic device. The SIM card 424 may include unique identification information (e.g., an integrated circuit card identifier (ICCID)) or subscriber information (e.g., international mobile subscriber identity (IMSI)).

The memory 430 (e.g., the memory 130) may include an internal memory 432 or an external memory 434. The internal memory 432 may include at least one of a volatile memory (e.g., a dynamic RAM (DRAM), a static RAM (SRAM), a synchronous dynamic RAM (SDRAM), or the like) or a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, a NOR flash memory, or the like).

According to an embodiment of the present disclosure, the internal memory 432 may be a solid state drive (SSD). The external memory 434 may include a flash drive, for example, compact flash (CF), secure digital (SD), micro secure digital (Micro-SD), mini secure digital (Mini-SD), extreme digital (xD), a memory stick, or the like. The external memory 434 may be functionally connected to the electronic device 400 through various interfaces. According to an embodiment of the present disclosure, the electronic device 400 may further include a storage device (or a storage medium) such as a hard drive.

The sensor module 440 may measure a physical quantity or detect an operation state of the electronic device 400 so as to convert measured or detected information into an electrical signal. The sensor module 440 may include, for example, at least one of a gesture sensor 440A, a gyro sensor 440B, an atmospheric pressure sensor 440C, a magnetic sensor 440D, an acceleration sensor 440E, a grip sensor 440F, a proximity sensor 440G, a color sensor 440H (e.g., a red/green/blue (RGB) sensor), a biometric sensor 440I, a temperature/humidity sensor 440J, an illumination sensor 440K, or an ultraviolet (UV) sensor 440M. Additionally or alternatively, the sensor module 440 may include, for example, (not shown) an olfactory sensor (E-nose sensor), an electromyography (EMG) sensor, an electroencephalogram (EEG) sensor, an electrocardiogram (ECG) sensor, an infrared (IR) sensor, an iris recognition sensor, a fingerprint sensor, or the like. The sensor module 440 may further include a control circuit for controlling at least one sensor included therein.

The input device 450 (e.g., the input module 140) may include a touch panel 452, a (digital) pen sensor 454, a key 456, or an ultrasonic input device 458. The touch panel 452 may recognize a touch input using at least one of capacitive, resistive, infrared and ultraviolet sensing methods. The touch panel 452 may further include a control circuit. In the case of using the capacitive sensing method, a physical contact recognition or proximity recognition is allowed. The touch panel 452 may further include a tactile layer. In this case, the touch panel 452 may provide tactile reaction to a user.

The (digital) pen sensor 454 may be implemented in a similar or same manner as that for receiving a touch input of a user, or may be implemented using an additional sheet for recognition. The key 456 may include, for example, a physical button, an optical button, or a keypad. The ultrasonic input device 458, which is an input device for generating an ultrasonic signal, may enable the electronic device 400 to sense a sound wave through a microphone (e.g., a microphone 488) so as to identify data, wherein the ultrasonic input device 458 is capable of wireless recognition. According to an embodiment of the present disclosure, the electronic device 400 may use the communication module 420 so as to receive a user input from an external device (e.g., a computer or a server) connected to the communication module 420.

The display 460 (e.g., the display 150) may include a panel 462, a hologram device 464, or a projector 466. The panel 462 may be, for example, a liquid crystal display (LCD) or an active-matrix organic light-emitting diode (AM-OLED). The panel 462 may be, for example, flexible, transparent or wearable. The panel 462 and the touch panel 452 may be integrated into a single module. The hologram device 464 may display a stereoscopic image in a space using a light interference phenomenon. The projector 466 may project light onto a screen so as to display an image. The screen may be disposed in the inside or the outside of the electronic device 400. According to an embodiment of the present disclosure, the display 460 may further include a control circuit for controlling the panel 462, the hologram device 464, or the projector 466.

The interface 470 may include, for example, a high-definition multimedia interface (HDMI) 472, a universal serial bus (USB) 474, an optical interface 476, or a D-subminiature 478. Additionally or alternatively, the interface 470 may include, for example, a mobile high-definition link (MHL) interface, a SD card/multi-media card (MMC) interface, or an infrared data association (IrDA) interface.

The audio module 480 may convert a sound into an electrical signal or vice versa. The audio module 480 may process sound information input or output through a speaker 482, a receiver 484, an earphone 486, or the microphone 488.

According to an embodiment of the present disclosure, the camera module 491 may be used for shooting a still image or a video may include at least one image sensor (e.g., a front sensor or a rear sensor), a lens (not shown), an image signal processor (ISP) (not shown), or a flash (e.g., an LED or a xenon lamp) (not shown).

The power management module 495 may manage power of the electronic device 400. Although not illustrated, a power management integrated circuit (PMIC), a charger integrated circuit (IC), or a battery or fuel gauge may be included in the power management module 495.

The PMIC may be mounted on an integrated circuit or an SoC semiconductor. A charging method may be classified into a wired charging method and a wireless charging method. The charger IC may charge a battery, and may prevent an overvoltage or an overcurrent from being introduced from a charger. According to an embodiment of the present disclosure, the charger IC may include a charger IC for at least one of the wired charging method or the wireless charging method. The wireless charging method may include, for example, a magnetic resonance method, a magnetic induction method, an electromagnetic method, or the like, and may include an additional circuit, for example, a coil loop, a resonant circuit, a rectifier, or the like.

The battery gauge may measure, for example, a remaining capacity of the battery 496 and a voltage, current or temperature thereof while the battery is charged. The battery 496 may store or generate electricity, and may supply power to the electronic device 400 using the stored or generated electricity. The battery 496 may include, for example, a rechargeable battery or a solar battery.

The indicator 497 may indicate a specific state of the electronic device 400 or a part thereof (e.g., the AP 410), such as a booting state, a message state, a charging state, or the like. The motor 498 may convert an electrical signal into a mechanical vibration. Although not illustrated, a processing device (e.g., a GPU) for supporting a mobile TV may be included in the electronic device 400. The processing device for supporting a mobile TV may process media data according to the standards of digital multimedia broadcasting (DMB), digital video broadcasting (DVB), media flow, or the like.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

An electronic device according to various embodiments of the present disclosure may include a communication module including a routing table for storing routing paths for short-range wireless communication payment, the communication module being configured to route an AID selection signal to an SE according to the routing paths stored in the routing table upon receiving the AID selection signal from a payment reader, a memory configured to store an AID list including a routing path of a short-range wireless communication payment application installed in the electronic device, and a control module configured to search the AID list for an AID corresponding to the AID selection signal if a routing path corresponding to the AID selection signal does not exist in the routing table or a response of the SE to the routing indicates unavailability of payment, and to store a routing path of an AID corresponding to a routing path selection signal in the routing table if the routing path corresponding to the routing path selection signal exists in the AID list.

According to an embodiment of the present disclosure, the routing path may be an AID routing path, a protocol routing path, or a technology routing path.

According to an embodiment of the present disclosure, the electronic device may further include a display for displaying a UI for selecting one of a plurality of AIDs corresponding to the AID selection signal if there exists the plurality of AIDs corresponding to the AID selection signal in the AID list.

According to an embodiment of the present disclosure, the electronic device may further include an input module for receiving a user input for selecting one of the plurality of AIDs if there exists the plurality of AIDs corresponding to the AID selection signal in the AID list.

According to an embodiment of the present disclosure, the control module may store, in the routing table, a routing path of an AID selected according to the user input.

According to an embodiment of the present disclosure, if there exists the plurality of AIDs corresponding to the AID selection signal in the AID list, the control module may store, in the routing table, a routing path of one of the plurality of AIDs according to a specified priority order.

According to an embodiment of the present disclosure, if a space for storing a routing path corresponding to the AID selection signal is insufficient in the routing table, the control module may delete at least a portion of the routing paths stored in the routing table.

According to an embodiment of the present disclosure, if a space for storing a routing path corresponding to the AID selection signal is insufficient in the routing table, the control module may delete at least a portion of the routing paths stored in the routing table in an ascending order of frequency of use.

According to an embodiment of the present disclosure, if a space for storing a routing path corresponding to the AID selection signal is insufficient in the routing table, the control module may delete at least a portion of the routing paths stored in the routing table in an order of storage time.

According to an embodiment of the present disclosure, the electronic device may further include a display for displaying a UI for providing a guide for tapping the electronic device on the payment reader if the routing path corresponding to the AID selection signal is stored in the routing table.

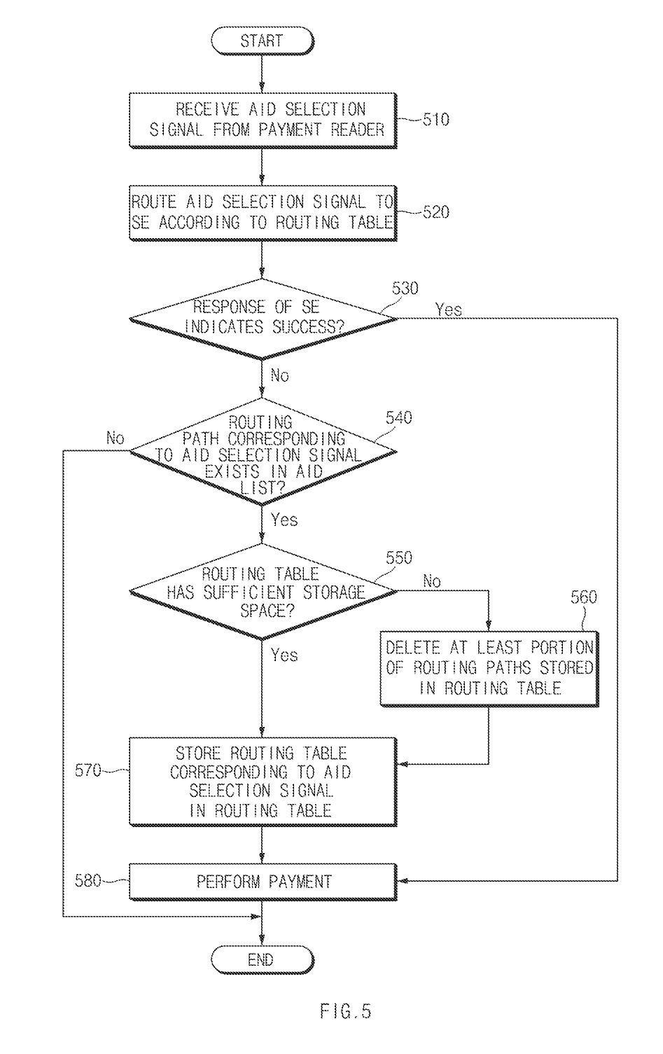

FIG. 5 is a flowchart illustrating a payment method for an electronic device according to an embodiment of the present disclosure.

The flowchart illustrated in FIG. 5 may include operations that are performed in at least one of the electronic device 100 illustrated in FIG. 1 or the electronic device 400 illustrated in FIG. 4. Therefore, the above descriptions of the electronic device 100 illustrated in FIG. 1 or the electronic device 400 illustrated in FIG. 4 may be applied to the flowchart illustrated in FIG. 5 even though the descriptions are omitted below. For convenience in description, FIG. 5 is described below with reference to FIG. 1 rather than both FIG. 1 and FIG. 4.

Referring to FIG. 5, the electronic device 100 may receive an AID selection signal from an external payment reader at operation 510. For example, if the electronic device 100 is tapped on the payment reader, the electronic device 100 may receive the AID selection signal from the payment reader. The AID selection signal may include information on a specific AID with which payment is to be performed.

Upon receiving the AID selection signal, the electronic device 100 may route the AID selection signal to an SE according to a routing path stored in a routing table at operation 520. According to an embodiment of the present disclosure, the communication module 110 may perform AID-based routing, protocol-based routing, or technology-based routing. For example, in the case where the routing path of a Samsung card AID is set to be a USIM in the routing table 112, the Samsung card AID selection signal received from the payment reader may be routed to the USIM. For another example, in the case where the routing path of a protocol A is set to be an eSE in the routing table 112, if the AID selection signal received from the payment reader is a signal of the protocol A, the AID selection signal may be routed to the eSE.

According to an embodiment of the present disclosure, the communication module 110 may perform routing in an order of AID-based routing, protocol-based routing, and technology-based routing.

The electronic device 100 may determine whether a response of the SE to the routing indicates success at operation 530. For example, upon receiving the AID selection signal, the SE may determine whether payment is able to be performed with an AID corresponding to the AID selection signal (or whether payment information corresponding to the AID selection signal exits).

If the response of the SE indicates success, the electronic device 100 may perform payment at operation 580. If there is no response of the SE (e.g., if routing fails since there is no routing path corresponding to the AID selection signal in the routing table) or the response of the SE indicates failure, the electronic device 100 may search an AID list for an AID corresponding to the AID selection signal in operation 540. The AID list may include information on a routing path of a payment application (or AID) installed in the electronic device 100. For example, the AID list may include information on what payment application is included for each SE of the electronic device 100 or what AID is included for each application.

If there is no AID corresponding to the AID selection signal in the AID list, the process may end.

If there exists an AID corresponding to the AID selection signal in the AID list, the electronic device 100 may determine whether the routing table has a sufficient space for storing a routing path corresponding to the AID selection signal at operation 550. According to an embodiment of the present disclosure, if there exists a plurality of AIDs corresponding to the AID selection signal in the AID list, the electronic device 100 may select one of the plurality of AIDs (or one of applications including respective AIDs). For example, the electronic device 100 may select one of the plurality of AIDs according to a user input for selecting one of the plurality of AIDs. For another example, the electronic device 100 may select one of the plurality of AIDs according to a specified priority order.

If the routing table does not have a sufficient storage space, the electronic device 100 may delete at least a portion of the routing paths stored in the routing table at operation 560. For example, the electronic device 100 may delete at least a portion of the routing paths stored in the routing table in an ascending order of frequency of use. For another example, the electronic device 100 may delete at least a portion of the routing paths stored in the routing table 112 in an order of storage time (e.g., in a first-in first-out manner). If at least a portion of the routing paths stored in the routing table is deleted, the electronic device 100 may store the routing path corresponding to the AID selection signal in the routing table at operation 570.

If the routing table has a sufficient storage space, the electronic device 100 may store the routing path corresponding to the AID selection signal in the routing table at operation 570.

For example, in the case of attempting to perform AID-based routing, an AID routing path corresponding to the AID selection signal may be stored in the routing table. According to an embodiment of the present disclosure, the electronic device 100 may store, in the routing table, routing paths of all AIDs related to a payment application including an AID corresponding to the AID selection signal.

If the routing path corresponding to the AID selection signal is stored in the routing table, the electronic device 100 may perform routing according to an updated routing path so as to perform payment at operation 580. For example, if the routing table 112 is updated, the electronic device 100 may automatically perform routing according to an updated routing path. Accordingly, even if payment fails due to a limitation in capacity of the routing table, the electronic device 100 may perform payment without allowing the user to be aware of the payment failure. For another example, if the electronic device 100 is tapped on the payment reader again after the routing table 112 is updated, the electronic device 100 may perform routing according to an updated routing path.

According to an embodiment of the present disclosure, if the routing path corresponding to the AID selection signal is stored in the routing table, the electronic device 100 may display a UI for providing a guide for tapping the electronic device 100 to the payment reader. Accordingly, even if payment fails due to a limitation in capacity of the routing table, the user may perform payment with ease through a UI provided by the electronic device, without manually updating the routing table.

According to various embodiments of the present disclosure, a payment method for an electronic device may include receiving an AID selection signal from a payment reader, routing the AID selection signal to an SE according to a routing table in which routing paths for short-range wireless communication payment are stored, searching an AID list including a routing path of a short-range wireless communication payment application installed in the electronic device for an AID corresponding to the AID selection signal if a routing path corresponding to the AID selection signal does not exist in the routing table or a response of the SE to the routing indicates failure, and storing the routing path corresponding to the AID selection signal in the routing table if the AID corresponding to the AID selection signal exists in the AID list.

According to an embodiment of the present disclosure, the routing path may be an AID routing path, a protocol routing path, or a technology routing path.

According to an embodiment of the present disclosure, the payment method may further include displaying a UI for selecting one of a plurality of AIDs corresponding to the AID selection signal if there exists the plurality of AIDs corresponding to the AID selection signal in the AID list.

According to an embodiment of the present disclosure, the storing of the routing path in the routing table may include receiving a user input for selecting one of the plurality of AIDs corresponding to the AID selection signal if there exists the plurality of AIDs corresponding to the AID selection signal in the AID list, and storing, in the routing table, a routing path of an AID selected according to the user input.

According to an embodiment of the present disclosure, the storing of the routing path in the routing table may include storing, in the routing table, a routing path of one of the plurality of AIDs in a specified priority order if there exists the plurality of AIDs corresponding to the AID selection signal in the AID list.

According to an embodiment of the present disclosure, the payment method may further include deleting at least a portion of the routing paths stored in the routing table if a space for storing a routing path corresponding to the AID selection signal is insufficient in the routing table.

According to an embodiment of the present disclosure, the deleting of at least a portion of the routing paths stored in the routing table may include deleting at least a portion of the routing paths stored in the routing table in an ascending order of frequency of use.

According to an embodiment of the present disclosure, the deleting of at least a portion of the routing paths stored in the routing table may include deleting at least a portion of the routing paths stored in the routing table in an order of storage time.

According to an embodiment of the present disclosure, the payment method may further include displaying a UI for providing a guide for tapping the electronic device on the payment reader if the routing path corresponding to the AID selection signal is stored in the routing table, and performing routing according to the routing path stored in the routing table if the electronic device is tapped on the payment reader.

The above-described payment method for an electronic device according to various embodiments of the present disclosure may be implemented with an executable program. This program may be stored in various types of non-transitory recording media.

In detail, a program code for performing the above-described methods may be stored in various nonvolatile recording media such as a flash memory, a read only memory (ROM), an erasable programmable ROM (EPROM), an electronically erasable and programmable ROM (EEPROM), a hard disk, a removable disk, a memory card, a USB memory, a CD-ROM, and the like.

According to various embodiments of the present disclosure, a routing table that is limited in capacity may be efficiently used, and, even if payment failure occurs due to the limitation in capacity of the routing table, a user may perform payment normally without being aware of the payment failure so that user inconvenience may be avoided.

Furthermore, even if the payment failure occurs due to the limitation in capacity of the routing table, the user does not need to manually update the routing table and may perform payment with ease without an analysis on a cause of the payment failure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication module comprising a routing table for storing routing paths for short-range wireless communication payment, wherein the communication module is configured to route an application identifier (AID) selection signal to a secure element (SE) according to the routing paths stored in the routing table when the AID selection signal is received from a payment reader;
a memory configured to store an AID list comprising a routing path of a short-range wireless communication payment application installed in the electronic device; and
a control module configured to:
search the AID list for an AID corresponding to the AID selection signal if a routing path corresponding to the AID selection signal does not exist in the routing table or a response of the SE to the routing indicates failure, and
control to store a routing path of an AID corresponding to a routing path selection signal in the routing table if the routing path corresponding to the routing path selection signal exists in the AID list.

2. The electronic device of claim 1, wherein the routing path comprises at least one of an AID routing path, a protocol routing path and a technology routing path.

3. The electronic device of claim 1, further comprising a display,
wherein the control module is further configured to control the display to display a user interface (UI) for selecting one of a plurality of AIDs corresponding to the AID selection signal if there exists the plurality of AIDs corresponding to the AID selection signal in the AID list.

4. The electronic device of claim 1, further comprising:
an input module configured to receive a user input for selecting one of a plurality of AIDs when there exists the plurality of AIDs corresponding to the AID selection signal in the AID list,
wherein the control module controls to store, in the routing table, a routing path of an AID selected according to the user input.

5. The electronic device of claim 1, wherein, if there exists a plurality of AIDs corresponding to the AID selection signal in the AID list, the control module is further configured to control to store, in the routing table, a routing path of one of the plurality of AIDs according to a specified priority order.

6. The electronic device of claim 1, wherein, if a space for storing a routing path corresponding to the AID selection signal is insufficient in the routing table, the control module controls to delete at least a part of the routing paths stored in the routing table.

7. The electronic device of claim 6, wherein, if the space for storing the routing path corresponding to the AID selection signal is insufficient in the routing table, the control module controls to delete at least a part of the routing paths stored in the routing table in an ascending order of frequency of use.

8. The electronic device of claim 6, wherein, if the space for storing the routing path corresponding to the AID selection signal is insufficient in the routing table, the control module controls to delete at least a portion of the routing paths stored in the routing table in an order of storage time.

9. The electronic device of claim 1, further comprising a display,
wherein the control module further configured to control the display to display a user interface (UI) for providing a guide for tapping the electronic device on the payment reader if the routing path corresponding to the AID selection signal is stored in the routing table.

10. A payment method for an electronic device, the method comprising:
receiving an application identifier (AID) selection signal from a payment reader;
routing the AID selection signal to a secure element (SE) according to a routing table in which routing paths for short-range wireless communication payment are stored;
searching an AID list comprising a routing path of a short-range wireless communication payment application installed in the electronic device for an AID corresponding to the AID selection signal if a routing path corresponding to the AID selection signal does not exist in the routing table or a response of the SE to the routing indicates failure; and
storing the routing path corresponding to the AID selection signal in the routing table if the AID corresponding to the AID selection signal exists in the AID list.

11. The method of claim 10, wherein the routing path comprises at least one of an AID routing path, a protocol routing path and a technology routing path.

12. The method of claim 10, further comprising displaying a user interface (UI) for selecting one of a plurality of AIDs corresponding to the AID selection signal if there exists the plurality of AIDs corresponding to the AID selection signal in the AID list.

13. The method of claim 10, wherein the storing of the routing path in the routing table comprises:
receiving a user input for selecting one of a plurality of AIDs corresponding to the AID selection signal when there exists the plurality of AIDs corresponding to the AID selection signal in the AID list; and
storing, in the routing table, a routing path of an AID selected according to the user input.

14. The method of claim 10, wherein the storing of the routing path in the routing table comprises storing, in the routing table, a routing path of one of a plurality of AIDs in a specified priority order if there exists the plurality of AIDs corresponding to the AID selection signal in the AID list.

15. The method of claim 10, further comprising deleting at least a portion of the routing paths stored in the routing table if a space for storing a routing path corresponding to the AID selection signal is insufficient in the routing table.

16. The method of claim 15, wherein the deleting of at least a portion of the routing paths stored in the routing table comprises deleting at least a part of the routing paths stored in the routing table in an ascending order of frequency of use.

17. The method of claim 15, wherein the deleting of at least a portion of the routing paths stored in the routing table comprises deleting at least a portion of the routing paths stored in the routing table in an order of storage time.

18. The method of claim 10, further comprising:
displaying a user interface (UI) for providing a guide for tapping the electronic device on the payment reader if the routing path corresponding to the AID selection signal is stored in the routing table; and
performing routing according to the routing path stored in the routing table if the electronic device is tapped on the payment reader.

19. A non-transitory computer-readable recording medium for recording a program for carrying out a method comprising:
receiving an application identifier (AID) selection signal from a payment reader;
routing the AID selection signal to a secure element (SE) according to a routing table in which routing paths for short-range wireless communication payment are stored; searching an AID list comprising a routing path of a short-range wireless communication payment application installed in the electronic device for an AID corresponding to the AID selection signal if a routing path corresponding to the AID selection signal does not exist in the routing table or a response of the SE to the routing indicates failure; and
storing the routing path corresponding to the AID selection signal in the routing table if the AID corresponding to the AID selection signal exists in the AID list.
